(19) United States
(12) Patent Application Publication
(10) Pub. No.: US 2014/0101036 A1
(43) Pub. Date: Apr. 10, 2014

(54) METHODS AND SYSTEMS FOR CONDUCTING REMOTE POINT OF SALE TRANSACTIONS

(71) Applicant: MasterCard International Incorporated, Purchase, NY (US)

(72) Inventors: Simon Phillips, York (GB); Mehdi Collinge, Braine-I'Alleud (BE); Jonathan James Main, Hook (GB)

(73) Assignee: MasterCard International Incorporated, Purchase, NY (US)

(21) Appl. No.: 14/050,974

(22) Filed: Oct. 10, 2013

Related U.S. Application Data
(60) Provisional application No. 61/711,901, filed on Oct. 10, 2012.

(51) Int. Cl. G06Q 20/32; G06Q 20/38; G06Q 20/10

(52) U.S. Cl. CPC G06Q 20/322; G06Q 20/10; G06Q 20/38
USPC 705/39

(57) ABSTRACT

Systems, methods, apparatus and computer program code are provided for operating a mobile device to conduct a transaction which include obtaining, by a mobile device operating a mobile payment application, a transaction payload from a merchant, extracting a payment gateway identifier from the transaction payload and establishing a secure communication channel with a payment gateway identified by the payment gateway identifier, receiving, from the payment gateway, item data associated with the transaction, the item data obtained by the payment gateway from the merchant, and receiving, from a user operating the mobile device, a confirmation to complete the transaction using a payment account associated with the user and transmitting the confirmation to the payment gateway with payment account credentials associated with the payment account.

### RELATED APPLICATION

This application claims benefit of and priority to U.S. Provisional Patent Application Ser. No. 61/711,901 filed on Oct. 10, 2012, the contents of which are hereby incorporated by reference in their entirety for all purposes.

### FIELD

The present disclosure relates generally to techniques for conducting transactions, and more particularly to techniques for conducting point of sale transactions over a remote connection.

### BACKGROUND

Payment cards such as credit or debit cards are ubiquitous and for decades such cards have included a magnetic stripe on which the relevant account number is stored. Traditionally, to consummate a purchase transaction with such a card, the card is swiped through a magnetic stripe reader that is part of the point of sale (POS) terminal. The reader reads the account number from the magnetic stripe. The account number is then used to route a transaction authorization request that is initiated by the POS terminal

Today, these card-based transactions are typically performed across multiple channels of commerce. For example, card-based transactions may be performed in person at a retail outlet, via a computer connected to the internet, via a mobile phone and/or via a company-based call center (e.g., a 1-800 number for a catalog company). These various transactions are conducted in different ways and, accordingly, have different levels of fraud risk associated therewith. In addition, transactions generally require that the consumer have his or her card in hand to either present to the cashier in a retail environment, or to enter the requested information via the internet and/or over the telephone. Those knowledgeable in the field will recognize that the risk of financial fraud is greater during remote transactions (also known as “card not present” transactions) because there is less ability for the merchant to verify the identity and authenticity of the cardholder.

In attempts to provide an additional security layer for online credit and debit card transactions, several different protocols have been adopted by payment card networks. For example, MasterCard International Incorporated provides the MasterCard SecureCode service. Other payment networks use similar services, generally based on the 3-D Secure protocol. Each of these services generally add an additional online authentication process to the standard financial authorization process to reduce fraud in card not present transactions, including electronic commerce (“e-commerce”) and mobile commerce (“m-commerce”) transactions.

Existing online authentication processes involve a number of participants and messages. For example, in a typical SecureCode authentication process, a cardholder that wishes to make a purchase transaction over the Internet operates a computer and shops at a merchant website. To initiate the purchase, the cardholder provides payment card information (including a primary account number or “PAN”, expiry data, a cardholder verification value or “CVC2”, address information and the like). The data is provided to the merchant over a secure socket layer (“SSL”) connection. The merchant website then provides SSL and other data to a directory service (such as, for example, the MasterCard Directory service or the like) which identifies the relevant issuer of the payment card and interacts with an issuer service. The issuer service establishes a secure session with the merchant website. The cardholder is then prompted to enter a private code into a web page (e.g., presented during the shopping checkout process) and the private code is provided to the issuer for authentication. If the payment card and cardholder are authenticated, an authentication variable (“AAV”) is returned to the merchant and the merchant can then complete the transaction by submitting a payment authorization request through a gateway/acquirer system. The payment authorization request is then routed through the payment network to the issuer.

Such authentication processes provide a greater level of authentication during transactions. Unfortunately, however, such processes can be unwieldy and involve a large number of messages and participants. It would be desirable to provide online transaction processes that reduce fraud and risk, while minimizing the interactions and complexity of transactions. Further, it would be desirable to reduce the integration requirements of acquiring and authorizing such transactions, while allowing proximity payment transactions at point of sale locations as well as transactions at remote terminals (e.g., over the Internet).

The types and nature of remote transactions are also changing. For example, some of the fastest growing types of remote transactions are transactions involving a mobile device such as a mobile telephone. It would be desirable to provide transaction systems and methods which allow for increased convenience in such remote transactions, including those involving a mobile device.

### BRIEF DESCRIPTION OF THE DRAWINGS

Features and advantages of some embodiments of the present invention, and the manner in which the same are accomplished, will become more readily apparent upon consideration of the following detailed description of the invention taken in conjunction with the accompanying drawings, which illustrate preferred and example embodiments and which are not necessarily drawn to scale, wherein:

FIG. 1 is a block diagram that illustrates an online payment transaction pursuant to some embodiments.

FIGS. 2A-2C are block diagrams pursuant to some embodiments.

FIGS. 3-4 are flow diagrams pursuant to some embodiments.

FIG. 5 is a flow chart depicting steps performed by an example mobile application pursuant to some embodiments.

FIG. 6 is a block diagram pursuant to some embodiments.

FIG. 7 is a state diagram of an example payment gateway pursuant to some embodiments.

FIG. 8 is a block diagram representation of an example portable device as depicted in FIGS. 3-4 pursuant to some embodiments.

FIG. 9 is a block diagram of a computer system pursuant to some embodiments.

### DESCRIPTION

Reference will now be made in detail to various embodiments of the invention. Examples of these embodiments are illustrated in the accompanying drawings. While the invention will be described in conjunction with these embodiments, it will be understood that it is not intended to limit the invention to any embodiment. On the contrary, it is intended to cover alternatives, modifications, and equivalents as may be included within the spirit and scope of the invention as defined by the appended claims. In the following description, numerous specific details are set forth in order to provide a thorough understanding of the various embodiments. However, the present invention may be practiced without some or all of these specific details. In other instances, well known process operations have not been described in detail in order to not unnecessarily obscure the present invention. Further, each appearance of the phrase “example embodiment” or “illustrative embodiment” at various places in the specification does not necessarily refer to the same example or illustrative embodiment.

Embodiments relate to transaction processes, and more particularly, to remote transaction processes. For example, a remote transaction process may include a process where a consumer is making a purchase or other transaction with a remote Web site or server (e.g., over the Internet) using a browser on a mobile device (such as a mobile telephone) A remote transaction process may also include a process where a consumer is making a purchase or other transaction with a remote Web site or server using a browser on a personal computer, tablet, or other Internet-connected device (such as a television or the like). In either embodiment, the transaction is completed using a mobile device associated with the consumer. As will be described further below, the mobile device is used to provide a secure and fast electronic commerce transaction. Embodiments allow the transaction to be considered a “card present” transaction (e.g., the transaction is treated as one in which the physical payment card was present in the transaction, providing a reduced fraud risk, and entitling the transaction to be treated as one conducted at a physical point of sale rather than a mail order or telephone transaction). As a result, the transaction process of the present application is suitable for use in a number of types of transactions, including high value transactions. Further, embodiments may be used in conjunction with non-payment transactions, such as, for example, transactions involving vouchers, coupons, loyalty points, electronic receipts or the like. Further, embodiments allow multiple payment accounts to be stored and accessed on the consumer's mobile device, providing greater convenience and choice.

A number of terms will be used herein. The use of such terms are not intended to be limiting, but rather are used for convenience and ease of exposition. For example, as used herein, the term “cardholder” may be used interchangeably with the term “consumer” and are used herein to refer to a consumer, individual, business or other entity that has been issued (or authorized to use) a financial account such as a credit or debit account. The financial account may be accessed by use of a “payment card” or “payment device” such as a traditional plastic or embossed magnetic stripe card, a chip card (such as an EMV card) or an RFID card (such as a PayPass card). Pursuant to some embodiments, as used herein, the term “payment card” or “payment device” may also include a mobile device (such as a mobile telephone) operating a payment application on which is stored payment account information. The term “MasterPass SE” may be used herein as a way to refer to the system of the present invention.

Several transaction embodiments will be described herein. In general, a first embodiment will be referred to as an “m-commerce embodiment”. In the m-commerce embodiment, a consumer may make a purchase (or other transaction) on a Web site that they are browsing on a browser of their mobile device. A transaction pursuant to the present invention may be initiated based on a direct trigger from the mobile browser (or by a merchant mobile application) or by a scan of a static Quick Response (“QR”) code from printed media (such as a billboard, a newspaper or magazine advertisement, etc.). Details of such m-commerce embodiments will be provided further below. A second embodiment will be referred to herein as an “e-commerce embodiment”. In the e-commerce embodiment, the consumer is conducting a purchase (or other transaction) from a remote merchant site that the consumer is browsing on a browser of a device such as a personal computer, tablet, television, or the like. During the browsing on the device, the consumer may be prompted (or choose) to conduct the transaction using their mobile device and may initiate the transaction by either scanning a dynamic QR code from the merchant site (e.g., by capturing the QR code from a display screen associated with the personal computer, tablet, television or the like) or by other methods which will be discussed further herein. In either embodiment, transactions conducted using the present invention provide reduced fraud risk, thereby allowing the transactions to be considered “card present” transactions. A number of other desirable results and features will become apparent to those skilled in the art upon reading the following disclosure.

Example embodiments allow a transaction over the Internet to have the same look and feel as a wireless transaction conducted in person at a POS terminal (such as a PayPass reader) at a store. In some embodiments, the consumer utilizes the same PIN that has been stored in the portable device for use in the wireless transaction at the store for transactions over the Internet.

The example embodiments do not require a separate authentication process to authenticate the cardholder and do not require the cardholder to remember a password different from the PIN or to enter an additional password during a transaction.

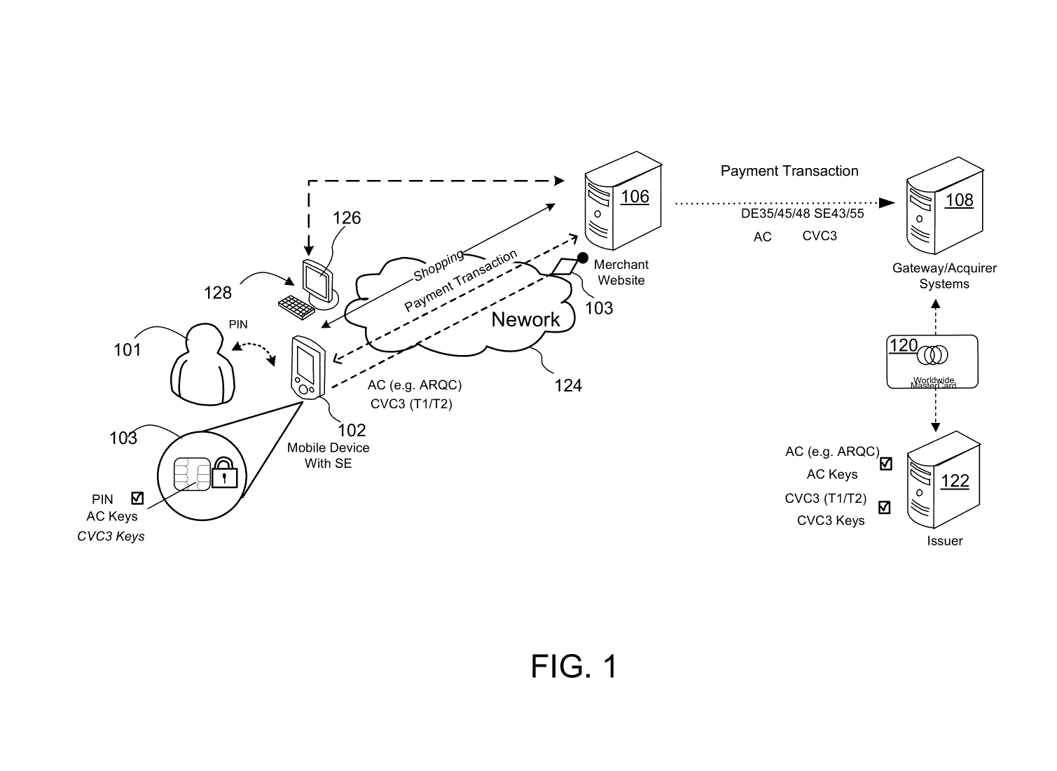

Reference is now made to FIG. 1 which is a block diagram of an example embodiment. FIG. 1 depicts aspects of a transaction involving a consumer 101 operating a mobile device 102 configured pursuant to the present invention (e.g., a mobile device operating a mobile application pursuant to the present invention) to conduct a transaction with a merchant 106 over a network connection 124. The transaction flow illustrated in FIG. 1 shows aspects of the present invention which may be present in both m-commerce and e-commerce embodiments. As shown, participants in a transaction include the consumer 101, the consumer's mobile device 102 (and, in some embodiments, a personal computer, or other device 126), a merchant website 106, a gateway/acquirer system 108, a payment network 120, and an issuer 122. In contrast to existing transaction flows, the transaction flow of the present invention requires fewer messages and participants in order to provide an authenticated transaction. Further, embodiments provide consumers with a familiar transaction flow, much like the transaction flow the consumer experiences at a physical point of sale location.

Pursuant to some embodiments, a consumer 101 utilizes a mobile device 102 to conduct transactions. The extent and nature of the involvement of the mobile device 102 depends on the type of transaction (e.g., whether it is an e-commerce or an m-commerce transaction). Differences in the consumer experience and transaction flow for different types of transactions will be described further below. The consumer's mobile device 102 (such as a mobile telephone) has a secure element 103 therein, with a mobile payment application stored thereon. The mobile payment application and the secure element 103 are personalized with payment account information, including one or more primary account numbers (“PAN”), a personal account number (“PIN”), authentication cryptogram (“AC”) keys, and card verification (“CVC3”) keys (as well as other payment account information such as, for example, an account expiry date, etc.). In some embodiments, the mobile device 102 may be one configured with the Android operating system (although iOS, and other mobile operating systems may also be used), and is capable of both cellular and wireless communication (e. g., via Wi-Fi, GPRS, 3G or other protocols). In an m-commerce embodiment, the mobile device uses wireless communication to establish a secure connection with a merchant website 103 executing on a merchant computer 104 (e.g., with the data communication occurring over a network such as network 124 (which may be, for example, the Internet or the like). In an e-commerce embodiment, the merchant website may be displayed on a web page on a screen 126 of the user's computer or tablet with web page enabling features that provide for remote shopping and payment that will be described in detail below.

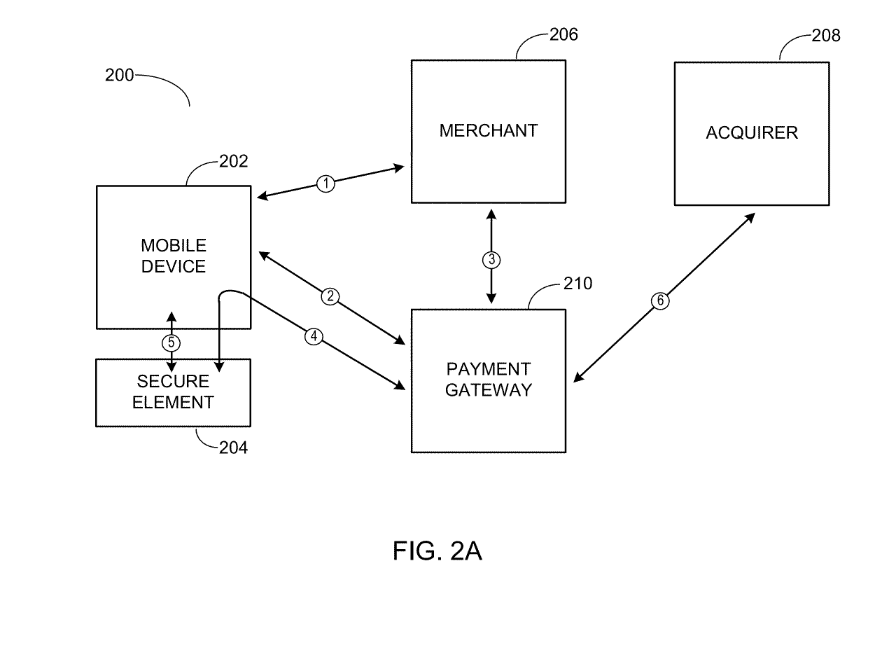

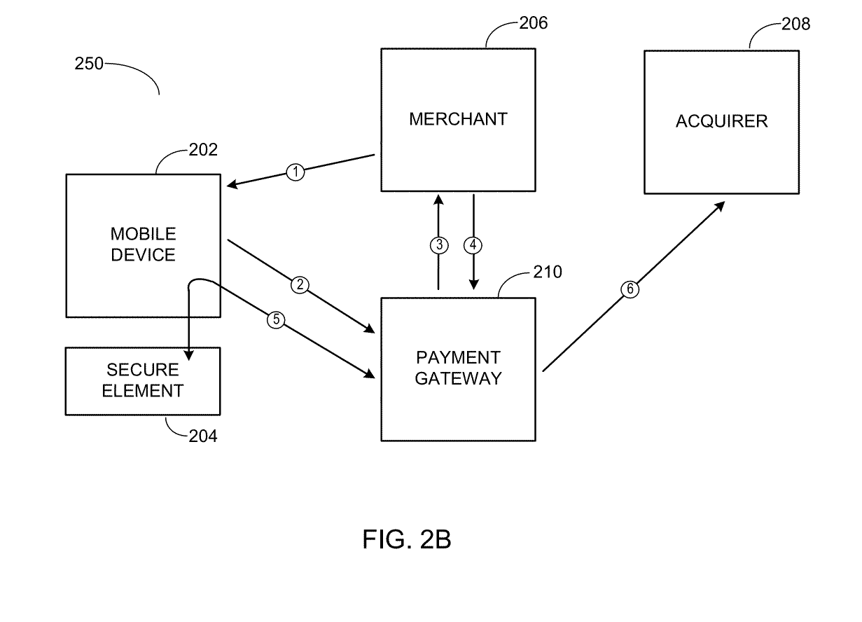

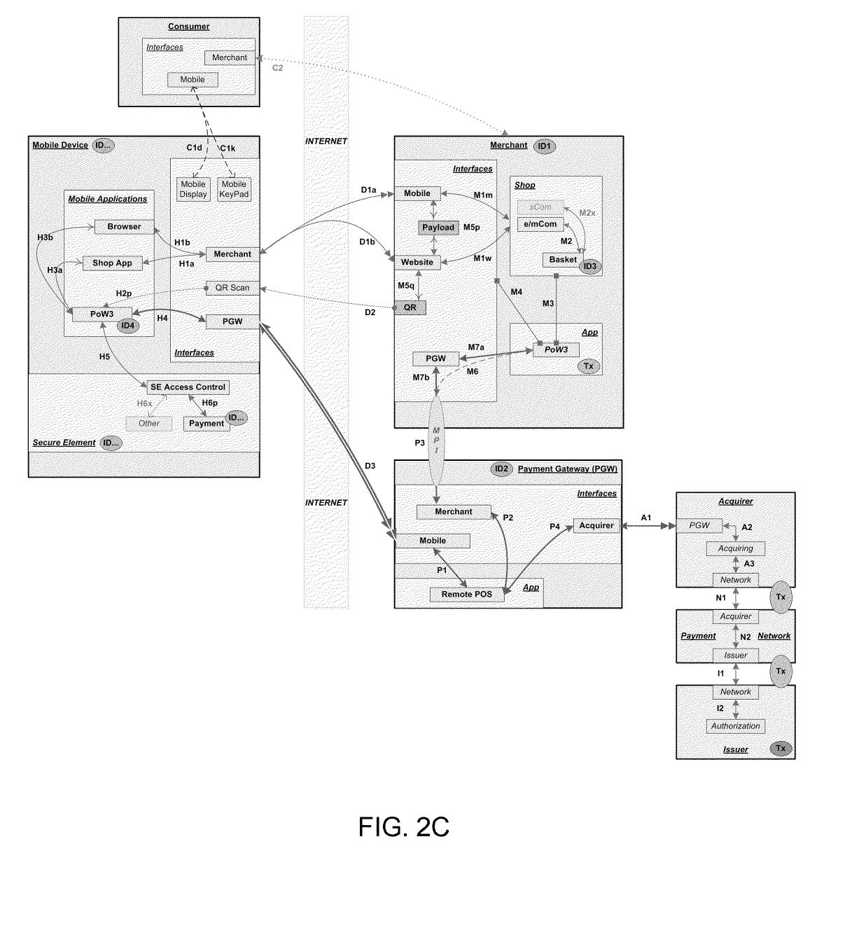

The secure connection between the consumer's mobile device 102 and the merchant 106 is established via a payment gateway as will be described further below. Once the connection is made to the payment gateway, the consumer is able to securely conduct a number of different types of transactions with remote merchants. Pursuant to some embodiments, a “transfer of trust” is performed (as described in FIG. 2 below) allowing a secure transfer of data between the mobile device 102, the payment gateway, and the merchant 104. The merchant computer 104 is coupled to a payment processing network, which, as depicted, includes gateway/acquirer systems 106, a payment network 108, and issuers 110.

Pursuant to some embodiments, the transfer of trust and transfer of data are configured to allow remote transactions to be conducted as if they were card present transactions (e.g., with a high level of authentication). Further, the transactions allow consumers to conduct remote transactions using their mobile devices such that the transaction is similar to a traditional point of sale transaction.

Features of the transaction flow which allows the transfer of trust 200 among the remote entities will now be described by reference to FIG. 2A which is a block diagram depicting participants in a transaction as well as the “transfer of trust” that is employed by embodiments of the present invention. As shown, a number of channels of communication or interactions are involved to facilitate transactions pursuant to the present invention. A first interaction (labeled as item “1”) involves interaction between a mobile device 202 and a merchant 206 in which the mobile device 202 (and the consumer operating the device) verify that the merchant 206 is the originator of the transaction. The first interaction may be over a wireless communications channel (e.g., such as a cellular data connection, an Internet connection, or the like). A second interaction (labeled as item “2”) involves interaction between the mobile device 202 and a payment gateway 210 in which the mobile device 202 verifies that the payment gateway 210 is a trusted provider for processing the transaction. In some embodiments, the payment gateway 210 is identified to the mobile device 202 during communication between the mobile device 202 and the merchant 206 (e.g., the merchant 206 may provide information identifying a specific gateway to be used for the transaction during interaction “1”).

A third interaction (labeled as item “3”) involves interaction between the merchant 206 and the payment gateway 210 in which the payment gateway 210 verifies the merchant as the originator of the transaction, and the merchant 206 verifies that the payment gateway 210 is the trusted service provider for processing the transaction.

A fourth interaction (labeled as item “4”) involves interaction between the payment gateway 210, the mobile device 202, and the secure element 204 on the mobile device. During communication over the fourth channel, the payment gateway 210 verifies the use of the secure element (and a mobile payment application stored thereon) and the consumer's presence (e.g., by prompting the consumer to respond to a PIN request, or to perform other processing such as described in the EMV specifications). A fifth interaction (labeled as item “5”) involves interaction between the mobile device 202 and the secure element 204, in which the mobile device 202 supports an access control to the secure element 204 (e.g., by processing a PIN entry or the like). In some embodiments, the access control can be enforced by the secure element 204 by itself. A sixth interaction (labeled as item “6”) involves interaction between the payment gateway 210 and the acquirer 208 (using existing payment processing protocols). The diagram of FIG. 2A is intended to provide a high level overview of the “transfer of trust” that occurs during transactions pursuant to the present invention, and further details will be provided further below.

Reference is now made to FIG. 2B, where a further block diagram is provided which shows the transfer of data in a transaction 250 involving a number of communication paths or interactions pursuant to the present invention. A first interaction (labeled as item “1”) occurs between the merchant 206 and the mobile device 202 in which the merchant 206 provides the mobile device 202 with a transaction payload (with details of the transaction to be conducted). The transaction payload information may be provided in a number of different ways (including, for example, via a QR code, as HTML data, or the like). The transaction payload may include a number of data elements including, for example, a version identifier (identifying the implemented version of the transaction payload), a merchant identifier (assigned by the payment gateway to uniquely identify the merchant), a merchant name (a human readable name usable to display to the user), a payment gateway identifier (to uniquely identify the payment gateway associated with the merchant), a basket identifier (which may be a dynamic value or a static value in the case of a sticker or poster), and a security seal (which may be, for example, a result of a cryptographic computation using a key or information shared between the merchant and the payment gateway). In some embodiments, a static flag may also be used. The static flag may be a merchant's unique static product(s)/service(s) identifier for use in static QR codes such as, for example, posters, flyers or other materials. The transaction payload may also include other optional data elements including, for example, a timestamp, one or more extensions or the like. This transaction payload information is used to deliver certain transaction details to other participants in a transaction as will be described further herein.

A second interaction (labeled as item “2”) occurs between the mobile device 202 and the payment gateway 210 in which the mobile device 202 displays information for visual confirmation by the consumer, and then the mobile device 202 uses a payment gateway identifier (which may be provided in the transaction payload at item “1” or otherwise identified by the mobile payment application) to determine which payment gateway 210 to connect to. Once the appropriate payment gateway 210 is identified, the mobile device 202 initiates a connection to that gateway 210, and transmits the transaction payload data plus additional data to create a unique identifier for the transaction.

A third interaction (labeled as item “3”) occurs between the payment gateway 210 and the merchant 206 in which the gateway 210 uses the merchant identifier (obtained from the transaction payload data) to determine which merchant the transaction originated from. The payment gateway 210 then connects to the appropriate merchant 206 and provides a “Basket ID” for the transaction (where the Basket ID is obtained from the transaction payload created in interaction “1”).

A fourth interaction (labeled as item “4”) occurs between the merchant 206 and the payment gateway 210, where the merchant 206 validates the basket ID received in message or interaction “3”, and uses the basket ID to lookup details of the transaction. The transaction details are then returned to the payment gateway 210 and may include, for example, the basket ID, a transaction amount, the relevant currency, etc. At this point in the transaction flow, the payment gateway 210 has information associated with the pending transaction, including the basket ID, the transaction details (including, for example, the transaction amount) and the transaction payload. The payment gateway 210 also has information about the mobile device 202 including a unique session identifier allowing communication between the payment gateway 210 and the mobile device 202/secure element 204.

A fifth interaction (labeled as item “5”) then occurs between the payment gateway 210 and the mobile device 202/secure element 204 in which the payment gateway 210 initiates a transaction (such as one compliant with the EMV standards promulgated by Europay, MasterCard and Visa) over a secure connection between the payment gateway 210 and the secure element 204 on the mobile device 202. The payment gateway 210, in this transaction, can be considered the Point of Sale terminal for the transaction, while the mobile device 202 can be considered to be the card reader for the transaction, and the secure element 204 can be considered to be the chip on a payment card for the transaction. In some embodiments, the transaction or interaction labeled as item “5” may include a request by the mobile device 202/secure element 204 to get the transaction details from the gateway 210. The gateway 210 may respond with the transaction details (received earlier from the merchant 206 in message or interaction “4”). The mobile application on the secure element 204 may compare a list of available payment accounts associated with the secure element 204 to a list of payment brand Application Identifiers (“AIDs”) that are identified in the transaction details to determine if the mobile device has an acceptable payment source that can be used to complete the transaction. As part of processing of the message or interaction at “5”, the mobile application may display, for each available line item in the transaction details, a product name, a product price, a quantity, and a line item total.

Processing of the message or interaction at “5” may also include processing of shipping information. For example, if the transaction details (provided from the merchant 206 to the payment gateway 210 at “4”, and from the payment gateway 210 to the mobile device 202 at “5”) indicate that shipping is required, then the mobile application may be operated to display shipping options to the customer on the display of the mobile device 202. For example, the mobile application may determine whether a default shipping address has been set. If so, the default shipping address is retrieved from the secure element 204 (or from a location identifiable by information in the secure element 204) and the shipping information is provided to the payment gateway 210. The customer may be provided with options to update or modify the default shipping address prior to transmission to the payment gateway 210.

Once the customer has reviewed the transaction details (and performed any shipping selections if required), a transaction summary may be presented on a display of the mobile device 202 and the customer is given the opportunity to finalize the transaction (e.g., by pressing a button or selector labeled “Pay” or the like). When the customer selects the “Pay” option, the mobile application causes a final transaction request message to be transmitted from the mobile device 202/secure element 204 to the payment gateway 210. In some embodiments, the customer may be required to enter a PIN before the final transaction request message is transmitted to the payment gateway 210. For example, the mobile application may determine that the transaction requires PIN entry (e.g., if the payment source selected for use in the transaction requires a PIN, etc.). In such situations, the mobile application causes a series of screens to be displayed to the customer prompting for PIN entry. The entered PIN is then compared to a stored PIN (or other information) in the secure element 204 to determine if there is a match before finalizing the transaction.

The transaction request message transmitted to the payment gateway 210 may be a transaction message based on the EMV specifications and may result in further request messages from the payment gateway 210 to the mobile application on the mobile device 202. For example, the payment gateway 210 may issue a request to process an application data protocol unit (“APDU”) and also to verify a PIN. The transaction request message transmitted from the mobile device 202 to the payment gateway 210 may, for example, be transmitted using a API call designed to start an EMV transaction and may include data such as the billing address, the cardholder name, and the email address associated with the selected payment source.

Once processing between the mobile device 202/secure element 204 and payment gateway 210 is completed, a sixth transfer (labeled as item “6”) then occurs between the payment gateway 210 and the acquirer 208 in which conventional payment processing occurs to perform a standard authorization request/response to complete the transaction. For example, the payment gateway 210 may cause ISO standard 8583 authorization messages to be transmitted to the acquirer 208 to complete the processing of the transaction. In some embodiments, the payment gateway 210 may return any authorization response codes or messages to the merchant 206 and/or the mobile device 202.

Pursuant to some embodiments, the transaction flows of FIG. 2 utilize a number of identifiers to support the messaging between participating devices and entities. For example, the mobile device 202 operates a mobile application configured pursuant to the present invention. The mobile application has or is associated with a unique identifier identifying the specific mobile application and device 202/204. The merchant 206 has a merchant identifier identifying the merchant. Each basket or transaction conducted with the merchant has a identifier (referred to herein as the “basket ID”) that allows the specific transaction details to be identified. The payment gateway 210 has an identifier (generally referred to herein as the “gateway ID”) that allows the merchant 206 and mobile device 202 to uniquely identify the appropriate payment gateway 210 for each transaction. Those skilled in the art, upon reading this disclosure, will appreciate that although a single mobile device 202, merchant 206 and payment gateway 210 are shown in FIG. 2, a large number of such devices will participate in a typical system.

While still referring to the transaction flow of FIG. 2B, further details of the use of the various identifiers to facilitation communication between devices will be described. As described above, in general, a five step process is followed to conduct transactions pursuant to some embodiments. A first step (labeled as message or interaction “1”) involves the initialization with delivery of a transaction payload to the mobile application of the mobile device 202. A second step (labeled as message or interaction “2”) involves the mobile application performing processing of the received transaction payload and establishing a connection to the payment gateway 210. A third step (labeled as message or interaction “3”) involves the payment gateway 210 performing a validation of the transaction payload by interacting with the merchant 206. A fourth step (labeled as message or interaction “4”) involves merchant 206 validation of the transaction payload and completion of the establishment of a session with the payment gateway 210. The session, in some embodiments, is established using identifiers from each of steps “1”-“4” (which may be referred to herein as identifiers {ID1}-{ID4}, where {ID1} is the merchant ID, {ID2} is the payment gateway ID, {ID3} is the basket ID, and {ID4} is the mobile application identifier on the mobile device). A fifth step (labeled as message or interaction “5”) involves use of a secure communication channel between the mobile application (on the mobile device 202) and the payment gateway 210 (and merchant) to support two logical channels (a control channel and a payment channel).

Further details of each of the interactions will now be provided. Processing at message or interaction “1” may involve three different embodiments, depending on whether the transaction is an m-commerce transaction or an e-commerce transaction. In the first embodiment, a mobile browser of the mobile device 202 is used to access a merchant website (e.g., represented by block 206). The interactions that are followed include interactions causing the mobile application to be initiated by the mobile browser to trigger or launch the mobile application and delivery of parameters returned by the merchant in the transaction payload. In some embodiments, the use of SSL may be used to secure communications between the mobile device and the merchant.

In a second embodiment, a mobile device 202 may use a merchant application (also referred to herein as a “Shop App”) to access the merchant. In such an embodiment, the Shop App is used to trigger the launch of the mobile application and delivery of parameters returned by the merchant (in a transaction payload). In some embodiments, the use of SSL may be used to secure communications between the mobile device 202 and the merchant 206.

In a third embodiment, a mobile device 202 may use a QR scan (to scan a QR code displayed at the merchant 206, or on some other printed or other material) to access the merchant. In such an embodiment, the mobile application is launched by the consumer and is used to scan the QR code. The transaction payload is received when scanning the QR code.

Processing at step “2” includes the mobile application receiving the transaction payload and performing the actions such as checking the message format, checking a payment gateway ID ({ID2}) against a list of trusted predefined payment gateway profiles stored in (or accessible to) the mobile application. The user may be prompted to verify the merchant name. Further, the mobile application may perform the following actions: connect to the payment gateway using connection information from the payment gateway profile stored in (or accessible to) the mobile application, and deliver a request message to the payment gateway. The request to the payment gateway 210 may include a transaction payload, a timestamp from the mobile application and the ID of the mobile application ({ID4}).

Processing at step “2” may include the payment gateway 210 performing actions including: checking the merchant ID ({ID1}) in the transaction payload against the payment gateway's list of registered merchants, validating the transaction payload seal (thereby also validating the merchant name and the binding with the merchant ID), optionally checking the merchant name value against the value stored in the merchant profile on the payment gateway 210, and initiating a connection (item “3”) to the merchant 206 using information stored in the merchant profile on the payment gateway 210. The interactions between the payment gateway 210 and the merchant 206 may be secured using a security model with the concept of a security token.

Processing at step “4” may include the merchant performing the following actions: validating the transaction payload seal, validating the basket ID ({ID3}), delivering information (such as the basket content, amount, currency or the like) to the payment gateway 210, and defining and establishing a session for {ID1}-{ID4}.

At this stage the secured communication channel between the mobile application (on the mobile device) and the payment gateway 210 can be used to support two logical channels—a control channel and a payment channel. The payment gateway 210 may then perform the following actions: supports the control channel with the mobile application ID ({ID4}) at the mobile device—this channel is used to signal state changes to the mobile device 202 (such as, for example, a signal that the transaction is complete), support the payment channel with the mobile application ID ({ID4}) at the mobile device 202—this channel is used to communicate with the EMV command and response APDU's between the payment gateway and the mobile device, support payment transaction (per EMV) and standard online transaction authorization, trigger cardholder verification methods (such as offline PIN) according to rules defined for products or BIN ranges. The mobile application at the mobile device 202 receives the response from the payment gateway 210 and facilitates one or more security control actions, including the use of a time-bound security token which can be used as a unique session identifier. The token may be presented as an argument of any API used by the payment gateway 210 to dialog with the mobile application (and the secure element). The mobile application may grant access to the secure element through any secure element access control rules. Interaction between the mobile application and the payment gateway 210 at step “5” also includes: validating the mobile application ID ({ID4}) originally defined at step “2”, supporting remote EMV transaction from the payment gateway using an SSL/TLS communication channel to exchange the messages handled by the payment gateway, and supporting user interface and interaction with the consumer using an SSL/TLS communication channel to exchange the messages handled by the control channel.

Reference is now made to FIG. 2C, where a further block diagram is shown which depicts, in more detail, the configuration of the devices and interactions during transactions. Shown are the consumer, the mobile device 202 (with secure element), the merchant 206, the payment gateway 210, the acquirer 208, the payment network 220, and the issuer 222 for a given transaction. Those skilled in the art will appreciate that while only one consumer, one mobile device, etc are shown in the diagrams of FIG. 2, that in practice, a large number of devices may be in communication (e.g., there may be a large number of consumers, mobile devices, merchants, acquirers and issuers interacting, further, there may be multiple payment networks).

As shown in FIG. 2C, the mobile device 202 includes several sub-components, including a mobile browser used for the browsing and purchase of goods or services (or for browsing and selecting other items to transact, including coupons, loyalty benefits, or the like) from a merchant's website. In some embodiments, the mobile device has one or more payment applications stored thereon, including a “shop app” (such as a shopping application issued by a merchant for the browsing and purchase of goods and services), and a mobile application (shown on the figure as “PoW3 application”) used for the user interface display during transactions and for support of transactions of the present invention. The mobile applications, in conjunction with the mobile device 202 cause the operation of several different interfaces, including a visual display that displays on a display device of the mobile device, as well as a merchant interface that controls data transmitted to and received from the merchant, a payment gateway interface that controls data transmitted to and received from the payment gateway, and a QR scan interface that provides an ability to scan and interpret a QR code on the mobile device (this interface is not required for m-commerce applications where transactions are triggered using the browser). The mobile device 202 also includes a secure element, which includes a secure element access control application (that controls communication to and from the secure element) and a mobile payment application (which may be, for example, based on the Mobile MasterCard PayPass M/Chip specification).

The merchant 206 consists of a number of subcomponents as well. For example, one or more merchant computer systems (such as, for example, Web servers) may operate a mobile application service that manages state information as well as information related to merchant transactions conducted pursuant to the present invention. A shop component may also be provided, which may, for example, include the merchant's existing application processes for handling e-commerce or m-commerce transactions. A shopping cart or “basket” component may also be provided to perform standard merchant shopping cart processes. The merchant computer may have a number of interfaces, including a mobile interface allowing interaction between the merchant 206 and mobile devices 202 operated by consumers, as well as a website interface which supports e-commerce transactions.

Pursuant to some embodiments, the merchant device 206 may also have a QR code interface that allows the merchant to provide a QR code based on the transaction payload generated for a specific transaction (such QR codes may, for example, only be generated for m-commerce transactions). A payment gateway interface may also be provided allowing interactions between the merchant device 206 and one or more payment gateways 210 for processing transaction detail requests and for the receipt of status updates involving transactions pursuant to the present invention. A transaction payload generator interface may also be provided, allowing the generation of transaction payloads for transactions involving the present invention.

The payment system may be viewed as consisting of several components, including one or more acquirers, payment networks (such as the BankNet network operated by MasterCard International Incorporated or the like) and issuers.

As shown in FIG. 2C, the payment gateway 210 includes a number of components, including, for example, a “Remote POS” component. In some embodiments, this Remote POS component is implemented as an API and is configured to perform the EMV processing of a payment against a selected payment account received from the mobile device 202. The Remote POS and the mobile device 202 communicate in real-time over a socket connection. The Remote POS drives this process by sending APDU commands down the socket connection to the mobile device 202 which then processes and responds to the commands. In some embodiments, the Remote POS can send the following types of APDUs to the mobile device 202: custom commands, and Remote POS commands. The custom commands are for specific activities for the mobile application to process, such as a Verify PIN activity, a status update, and a command to cause a message to be displayed. The Remote POS commands may be APDU commands sent from the Remote POS to the mobile device 202 which are not customized (for example, regular EMV commands, such as SELECT, READ RECORD, etc.). The socket connection between the payment gateway 210 and the mobile device 202 is encrypted for security. For example, the connection may be encrypted using the AES 256/PKCS #7 encryption method.

As shown in FIG. 2C, a number of interactions or connection points exist between components (for example, a connection labeled “C1d” exists between the display of the mobile device 206 and the consumer and represents an interaction between the consumer and the display of the mobile device 206). These interactions or connections are for illustrative purposes only—those skilled in the art, upon reading this disclosure, will appreciate that other interactions or connections may be used within the context of the present invention. The Tables 1-8 below provide a description of a number of the connection points shown in FIG. 2C pursuant to some embodiments.

For example, Table 1 shows interactions between the mobile device 202 and a consumer.

TABLE 1

| Label | Between | | Description |
|---|---|---|---|
| C1d | Mobile Display | Mobile Interface | User interaction |
| | (Mobile device) | (Consumer) | (display) |
| C1k | Mobile key pad | Mobile interface | User interaction (data |
| | (mobile device) | (consumer) | entry) |

Table 2 shows interactions between the mobile device 202 and other devices (such as the merchant 206). The different transaction scenarios are shown (e.g., such as e-commerce and m-commerce transactions).

TABLE 2

| Label | Between | | Description |
|---|---|---|---|
| H1b | Merchant interface | Browser | Mobile device (Shop |
| | | | App) requests from |
| | | | merchant: existing |
| | | | services such as |
| | | | products, shopping |
| | | | basket; transaction |
| | | | payload |
| H1a | Merchant interface | Shop App | Mobile device |
| | | | (browser) requests |
| | | | from merchant: |
| | | | existing services such |
| | | | as products or |
| | | | shopping basket; |
| | | | transaction payload |
| H2p | Mobile application | QR Scan interface | Mobile application |
| | | | scans a QR code |
| | | | from the merchant |
| H3a | Shop App | Mobile application | Shop App triggers |
| | | | launch of Mobile |
| | | | application with |
| | | | application payload |
| H3b | Mobile browser | Mobile application | Mobile browser |
| | | | triggers launch of |
| | | | Mobile application |
| | | | with transaction |
| | | | payload |
| H4 | Mobile application | Payment gateway | Mobile application |
| | | interface | requests the payment |
| | | | gateway process a |
| | | | given transaction |
| | | | payload |
| H5 | Mobile application | Secure element | Mobile application |
| | | access control | requests to access the |
| | | | payment application |
| H6p | Secure element | Payment | Access control to the |
| | access control | Application | secure element |

Table 3 shows interactions between the mobile device 202 and the merchant 206.

TABLE 3

| Label | Between | | Description |
|---|---|---|---|
| D1a | Merchant interface | Mobile interface | Mobile device (using |
| | (mobile device) | (merchant) | the Shop App) |
| | | | requests from the |
| | | | merchant: existing |
| | | | services such as |
| | | | product data and |
| | | | shopping card data; |
| | | | transaction payload |
| D1b | Merchant interface | Website interface | Mobile device |
| | (mobile device) | (merchant) | (browser) requests |
| | | | from merchant: |
| | | | existing services such |
| | | | as product data or |
| | | | shopping cart data; |
| | | | transaction payload |
| D2 | QR Interface | QR Scan interface | Mobile device scans |
| | (merchant) | (mobile device) | a QR code presented |
| | | | by the merchant QR |
| | | | interface |

Table 4 shows interactions by the merchant device 206.

TABLE 4

| Label | Between | | Description |
|---|---|---|---|
| M1m | Mobile interface | Shop | Mobile interface |
| | | | passes request to |
| | | | shop |
| M1w | Website interface | Shop | Website interface |
| | | | passes request to |
| | | | shop |
| M2 | e/m-commerce | Basket | e/m-commerce |
| | | | requests basket |
| | | | details |
| M3 | Shop | Mobile application | Exchange data |
| | | | between shop and |
| | | | Mobile application |
| M4 | Mobile application | [return path] | |
| M5p | Payload | Mobile/website | Provide transaction |
| | | interface | payload to |
| | | | mobile/website |
| | | | interface as required |
| M5q | Website interface | QR interface | Website interface |
| | | | requests QR code for |
| | | | display on the |
| | | | website |
| M6 | MPI | Mobile application | MPI requests |
| | | | transaction data from |
| | | | the Mobile |
| | | | application |
| M7a | Payment gateway | Mobile application | Payment gateway |
| | interface | | interface requests |
| | | | transaction data from |
| | | | Mobile application |
| M7b | MPI | Payment gateway | MPI requests |
| | | interface | transaction data from |
| | | | payment gateway |
| | | | interface |

Table 5 shows interactions between the mobile device 202 and the payment gateway 210.

TABLE 5

| Label | Between | | Description |
|---|---|---|---|
| D3 | Payment gateway | Mobile interface | Mobile device |
| | interface (mobile | (payment gateway) | requests the payment |
| | device) | | gateway process a |
| | | | transaction with the |
| | | | given transaction |
| | | | payload. The |
| | | | payment gateway |
| | | | sends C-APDU's |
| | | | (cardholder |
| | | | application data |
| | | | units) for processing. |
| | | | The mobile device |
| | | | returns R-APDU |
| | | | responses. The |
| | | | payment gateway |
| | | | sends status |
| | | | information. This |
| | | | interaction is over |
| | | | two channels: (1) a |
| | | | control channel, and |
| | | | (2) a payment |
| | | | channel. |

Table 6 shows interactions at the payment gateway 210.

TABLE 6

| Label | Between | | Description |
|---|---|---|---|
| P1 | Mobile interface | Remote POS | Mobile interface |
| | | | requests transaction |
| | | | to be processed by |
| | | | the remote POS. |
| P2 | Remote POS | Merchant interface | The remote POS |
| | | | requests the merchant |
| | | | interface to request |
| | | | transaction details |
| P4 | Remote POS | Acquirer Interface | The remote POS |
| | | | requests the Acquirer |
| | | | Interface to process |
| | | | authorization and |
| | | | settlement of the |
| | | | transaction |

Table 7 shows interactions between the payment gateway 210 and the merchant 206.

TABLE 7

| Label | Between | | Description |
|---|---|---|---|
| P3 | Merchant interface | Payment gateway | Payment gateway |
| | (payment gateway) | interface (merchant) | requests transaction |
| | | | information from the |
| | | | merchant |

Table 8 shows interactions between the payment gateway 210 and the payment system 220.

TABLE 8

| Label | Between | | Description |
|---|---|---|---|
| A1 | Acquirer interface | Payment gateway | Payment gateway |
| | (payment gateway) | interface (acquirer) | requests |
| | | | authorization and |
| | | | settlement via the |
| | | | acquirer as per |
| | | | existing processes. |

Those skilled in the art will appreciate that the above interactions are for illustrative purposes only and that variations thereof may be made while still achieving transactions pursuant to the present invention.

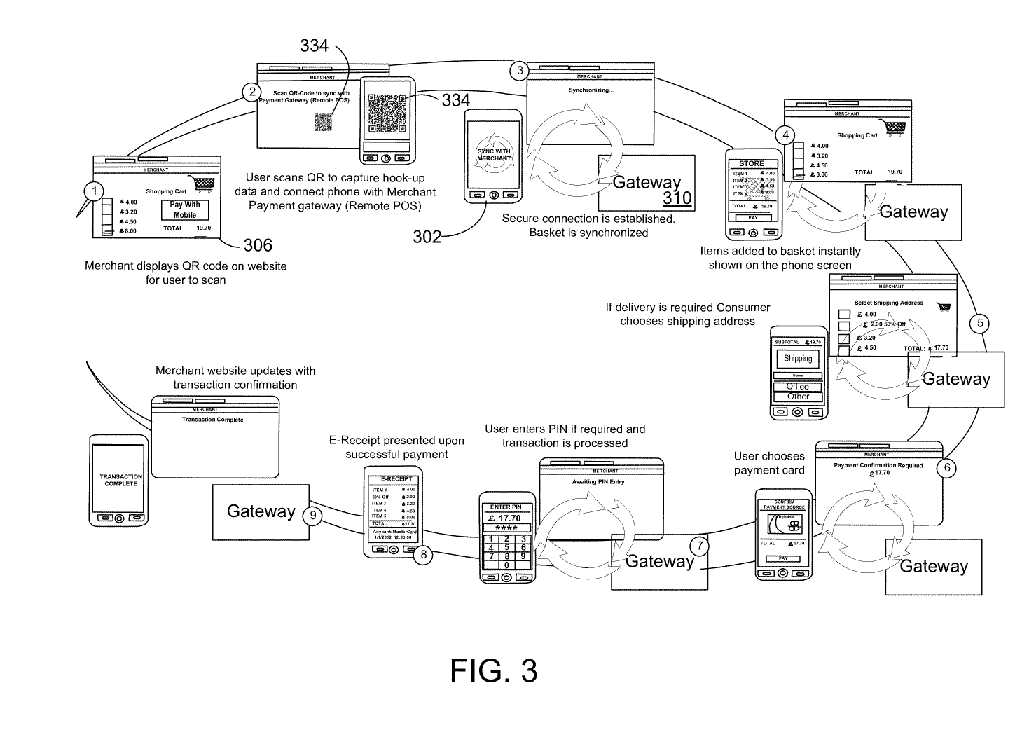

Reference is now made to FIG. 3 is a high level flow diagram depicting the user experience with an m-commerce embodiment. The operations performed will be described in detail below. In the transaction of FIG. 3, a user operating a mobile device 302 wishes to purchase item(s) from a merchant website 306 using the payment system of the present invention. For example, the user may be viewing a merchant website 306 on a personal computer, a laptop, via a set top box, or other user interface (such as a user interface associated with another mobile device, a television, a gaming console, or other display device), and then interact with their mobile device 302 to complete the purchase of one or more items. An illustrative transaction flow may proceed as follows. At step “1” of FIG. 3, a consumer or user browses a merchant website 304 using a device other than the user's mobile device 302. The user selects one or more items to purchase and the merchant website displays a code (such as a QR code or other identifier). At step “2” the user interacts with their mobile device 302 and launches a mobile application on the mobile device, and interacts with the mobile application to scan the QR code 334 or other identifier from the merchant website. The user may also be prompted to select a payment card or payment account for use in the transaction.

By capturing or reading the QR code 334 or other identifier, the mobile application is able to obtain merchant and transaction information in a transaction payload from the merchant website. For example, the transaction payload may include a merchant ID, a merchant name, a payment gateway ID, and a basket ID used to identify the user's item(s) to be purchased.

At step “3”, the mobile application causes the mobile device 302 to establish a secure connection with the payment gateway identified by the payment gateway ID obtained in the transaction payload. In the secure connection, the mobile application provides the payment gateway with the basket ID and information associated with the mobile application. The payment gateway 310 then establishes communication with the merchant 306 and obtains item details from the basket associated with the basket ID. The item(s) from the basket from the merchant website 306 may be displayed on a display of the mobile device 302 at step “4” for the user to view.

At step “5”, the merchant 306 provides the payment gateway 310 and the mobile application on the mobile device 302 with a request to select a shipping address (if the item(s) in the basket require shipping). In some embodiments, the user may configure one or more default or stored shipping preferences, and those stored shipping preferences may be displayed to the user on the display screen of the mobile device for confirmation. The user may also be provided with the option to enter a new or different shipping address by interacting with the mobile application on the mobile device 302. The shipping selection (if required) is then provided to the payment gateway 310 for use in the transaction. At “6”, the user may be prompted to select a payment source. In some embodiments, a secure element of the mobile device 302 may be personalized or configured with payment credentials (including PAN, expiry, CVV or the like) for one or more payment accounts, and at “6”, the user may be presented with an option to select which of the available payment accounts to use in the transaction. At “7” the mobile application may prompt the user to enter cardholder verification data (such as a PIN or password) if the selected payment account requires such cardholder verification. The user then submits the transaction for approval processing by the payment gateway. At “8”, the mobile application of the mobile device 302 may receive a confirmation of the completion of the transaction. At “9”, the merchant website may receive an update of the confirmation of the transaction. In this manner, embodiments allow secure payment transactions to be completed in online transactions using a mobile payment device storing payment credentials of a user. In some embodiments, the payment may be performed using in accordance with the EMV standards or other payment standards, allowing secure “card present” types of transactions to be conducted. In some embodiments, depending on the merchant implementation, such transactions may be used to allow a single click style of purchase of an individual product. Embodiments provide a clean separation of authentication and payment such that embodiments may support remote authentication. Further, the payment might be completed separately using some other means, such as a through the use of cloud-based payment credentials.

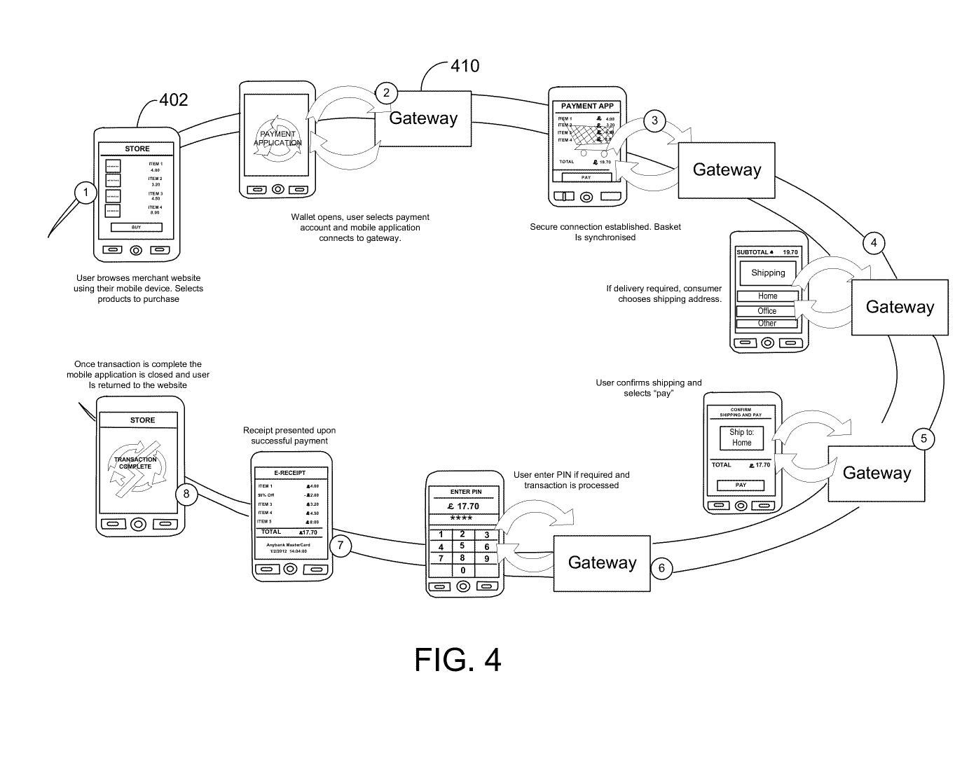

FIG. 4 is a high level flow diagram depicting the user experience with a second example embodiment. As described above, in the embodiment of FIG. 3 the user is shopping on a merchant website displayed on the screen of a device other than the user's mobile device, and uses a QR code or other identifier to launch the mobile application and complete the purchase transaction. In the embodiment of FIG. 4, the user is shopping using a merchant website or merchant application displayed on the screen of the mobile device 402. In the embodiment shown in FIG. 4, processing is shown as starting at step “1”, where the user has selected one or more items to purchase from a merchant website or merchant application. The user selects to pay using the mobile application and processing continues at “2” where the mobile application of the present invention is opened. As the mobile application is opened or activated, a transaction payload is provided from the merchant website or application to the mobile application. The mobile application uses information from the transaction payload to establish communication with the payment gateway 410 identified by the payment gateway ID contained in the transaction payload.

The gateway 410 uses the information provided from the mobile application to obtain transaction details from the merchant (e.g., by providing a basket ID from the transaction payload). The mobile application and the gateway 410 synchronize and the mobile application displays the basket contents. At “4” a determination is made whether shipping or delivery instructions are required for the items. If so, any preestablished shipping preferences of the user may be displayed as options for the user to select. The user confirms the shipping preferences and selects to complete the transaction at “5”. If the selected payment device requires some form of cardholder validation, a PIN or other validation step may occur at “6”. Once validation and confirmation of the transaction have been received from the user, the payment gateway 410 uses the selected payment credentials to complete the transaction. A receipt or confirmation may be provided to the mobile device 402 at “7” and the browser of the mobile device may be returned to the merchant confirmation page at “8”. In this manner, embodiments allow a payment process including a secure authentication method which does not involve the complexity of a typical SecureCode approach, allowing card-present type transactions to be efficiently and securely performed in mobile transactions.

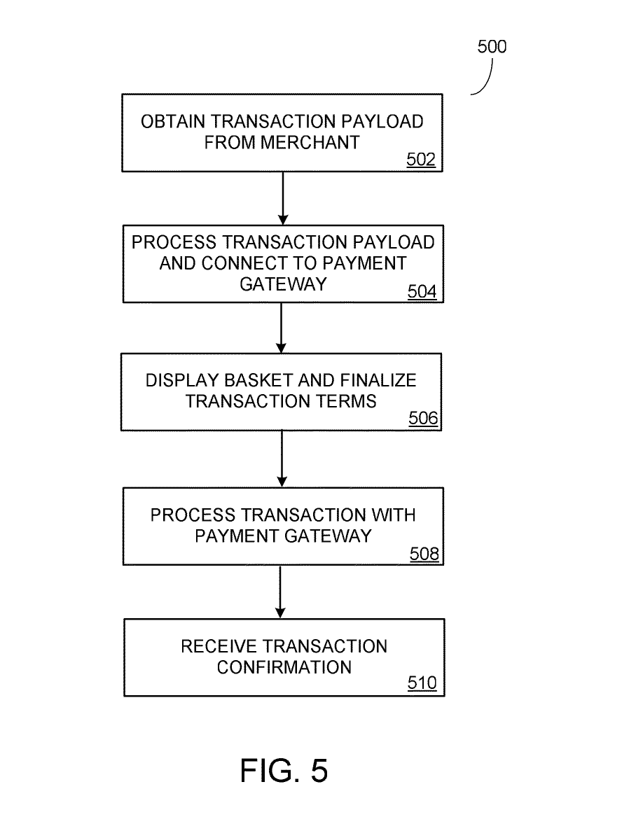

FIG. 5 is a flow chart showing an illustrative process 500 that may be performed by a mobile device (such as device 202 of FIG. 2) operating a mobile application to perform transactions pursuant to the present invention. As shown, process 500 may begin, for example, at 502 where the mobile device (operating the mobile application) obtains a transaction payload from a merchant. Processing at 502 may also include launching or loading the mobile application prior to, or in conjunction with, obtaining the transaction payload. The manner in which the transaction payload is captured may depend on the environment in which the transaction occurs. For example, in embodiments where the mobile device 202 is operated by a user to browse a merchant website, processing at 502 may include launching the mobile application from the browser and passing transaction payload data from the browser session to the mobile application. As another example, in embodiments where the mobile device 202 is operated by a user to interact with a merchant using a merchant application, processing at 502 may include launching the mobile application from the merchant application and passing transaction payload data from the merchant application to the mobile application. As yet another example, in embodiments where the mobile device 202 is operated by a user separate from a browsing or shopping transaction being conducted on a different device (such as a desktop, laptop, or other computing device), the transaction payload may be passed to the mobile application by capturing or scanning a QR code or other identifier. That is, the transaction payload data may be encoded in a QR code, bar code or other identifier and consumed by the mobile application at 502.

In some embodiments, the determination of how the transaction payload is provided to the mobile application 502 may be made, at least in part, by automatically generating a QR code on a merchant website if code on the merchant website determines that the device type of the user browsing the website is a personal computer, laptop or tablet. This may be identified, for example, by detecting the user agent data, referrer data and other browser data when a user interacts with the merchant website using a browser on a personal computer, laptop or tablet device. In such instances, the merchant website may generate a QR code using code provided by the merchant's payment gateway partner, for example. In situations where the merchant website detects that the user is browsing the merchant website using a mobile device, the transaction payload data may be encoded into a checkout button, providing the user with the option to use the payment processing method of the present invention as a payment option. For example, if the merchant website determines that the user is interacting with the merchant website with a device type that is a mobile device, an HTML action link may be rendered which displays a button (such as a button with the call to action of “Buy with MasterPass”) having an action link encoding transaction payload data in the action link. If the user selects the checkout option according to the present invention (by clicking on the button), the action link will cause the transaction payload data to be captured.

Once the mobile application has the transaction payload data, processing continues at 504 where the mobile application processes the transaction payload data and connects to the payment gateway. The payment gateway may be determined by a payment gateway ID obtained from the transaction payload from the merchant, and used by the mobile application to initiate a secure connection of the mobile device to the payment gateway (e.g., over a data or Internet connection). Processing at 504 may also include the payment gateway returning information to the mobile device. For example, the payment gateway 504 may establish a connection to the merchant and, using a basket ID obtained from the mobile application, retrieve transaction details from the merchant. These transaction details may be returned to the mobile application for display to the user at 506. Processing at 506 may include determining whether any special rules apply to the transaction. For example, if the transaction involves items to be delivered or shipped, processing at 506 may include determining whether any stored shipping preferences should be applied or provided to the user. As another example, processing at 506 may include determining whether any special offers, coupons or other benefits should be applied to the transaction. As still another example, processing at 506 may include determining what types of payment accounts may be used to conduct the transaction with the merchant. The final terms or details presented to the user at 506 may include the results of these rules.

Processing continues at 508 where the mobile application receives instructions and/or confirmation from the user to finalize the transaction. This may include, for example, a user selection of a shipping or delivery address, a user selection of a desired payment account, and/or a user entry of any required cardholder verification data. The mobile application causes a payment transaction to be initiated between the mobile device and the payment gateway. In some embodiments, the payment transaction is performed as an EMV-compliant transaction, although those skilled in the art, upon reading this disclosure, will appreciate that other payment standards may be used. At 510, processing on the mobile application completes with the receipt of a transaction confirmation from the payment gateway.

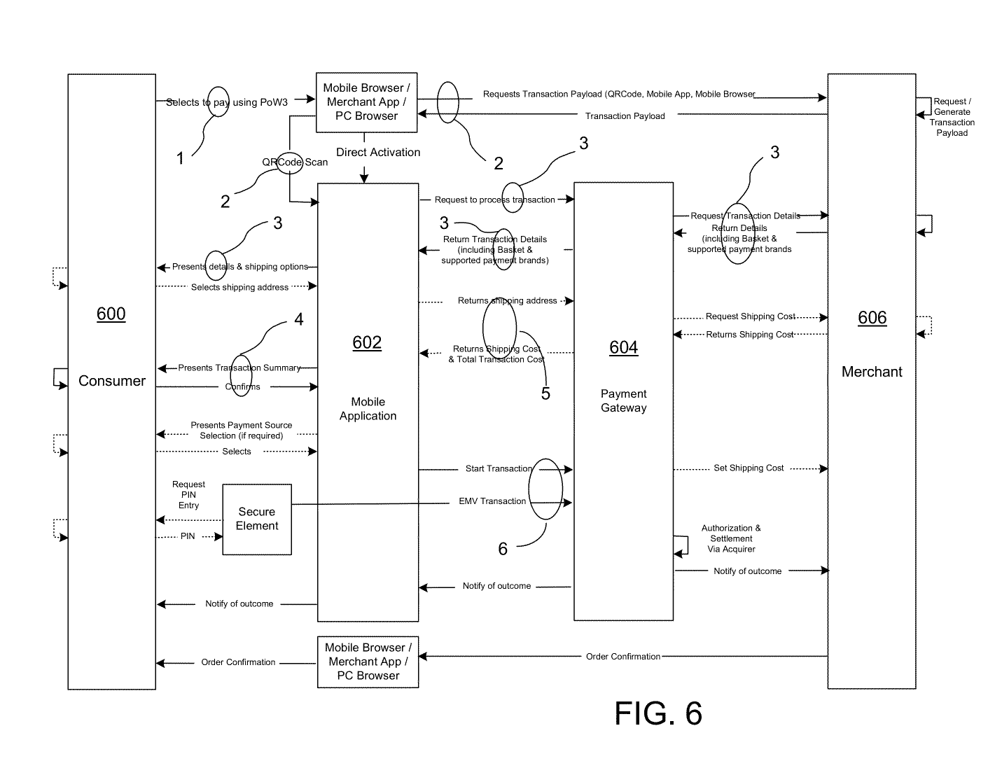

Reference is now made to FIG. 6 which is a schematic drawing depicting details of the interactions between devices (including a user interface of a mobile device, a mobile application, a payment gateway, and a merchant). FIG. 6 depicts a system of the present invention and provides a further illustration of the messages and interactions between the various devices in a transaction, including interactions between a consumer interface 600 of the mobile device, the mobile application 602 resident in the secure element of the mobile device, the payment gateway 604 and the merchant website 606. In the embodiment depicted in FIG. 6, the payment gateway 604 is not part of the merchant systems and, instead, may service a number of different merchants. A registration process between a merchant and the payment gateway configures the payment gateway to support secure interaction between mobile devices, merchants and payment gateways as described herein.

As depicted, the merchant website 606 includes software to control the interaction between the merchant and the payment gateway 604. For example, the merchant 606 may communicate with the payment gateway 604 using one or more APIs which may, for example, include a Get Transaction Payload request, a Cancel Transaction Request, a Validate request, a Get Transaction Details request, Get Shipping Options request and a Transaction Status update. Other API methods and interactions may also be used, and these methods are provided for illustrative purposes.

Several messages or interactions of FIG. 6 will be specifically described; others are described elsewhere herein. In general, a transaction pursuant to the present invention may commence when a consumer elects to conduct a purchase transaction using the present invention (e.g., by selecting a payment option that may be referred to as “Buy with MasterPass” or the like). An example is shown at item “1” where a consumer interacting with a merchant via a mobile browser, a merchant application or a browser of another device selects to pay using the system of the present invention. The mobile application is operated to obtain a transaction payload from the merchant. The transaction payload may be obtained by scanning a QR code or by otherwise passing the payload information from the merchant to the mobile application (as shown at “2”). For example, in the case where the user is interacting with a mobile browser or merchant mobile application on the mobile device, the mobile application is automatically opened when the buy button is clicked and the transaction payload is passed from the mobile browser or mobile merchant application. In the case where the user is shopping from the merchant website displayed on a computer screen (of another device) the user opens the mobile application and scans the QR code which contains the transaction payload. The remaining interactions may be are common for the mobile browser, mobile merchant application and merchant website cases.

In the interaction labeled as “3”, the mobile application connects to the payment gateway 604 and retrieves the transaction details. As depicted in FIG. 6, the API calls of the payment gateway 604 retrieve the transaction details from the merchant 606 and forward them to the mobile device 600 via the payment gateway 604. In the interaction labeled as “4”, the mobile application 602 displays the transaction basket for the user to confirm. In the interaction labeled as “5”, the mobile application 602 presents a list of options to the user (such as a list of available payment accounts, and a list of shipping options). The shipping options may include one or more pre-stored addresses established by the user. These addresses have previously been stored in the memory of the mobile device so that there is no need to enter them at the time of shopping. This is advantageous because of security and because entry of text on a mobile device is slow and difficult.

Many merchants will only ship to the billing address to prevent fraud. In an example embodiment, the billing address stored in the portable device can be digitally signed by both the issuer financial institution and by a payment association (such as MasterCard International Incorporated). In some embodiments, the merchant 606 has access to the issuer and payment association public keys and may confirm that the billing address is genuine. In some transactions the final transaction cost will depend on the shipping address or certain shipping addresses may be disallowed. In one example embodiment, the QR code is displayed on a merchant website early on in a transaction and the mobile application provides the shipping address before the buy button is activated so that the shipping address can be factored into the cost. During the interaction between the user and the transaction details, the user may be offered the ability to apply vouchers, discounts, or coupons stored on or accessible by the mobile device to reduce or modify the transaction details (such as the transaction total).

In the interactions labeled as items “6”, a payment transaction is performed by the mobile application 602 interacting with the payment gateway 606. A cardlet stored in the secure element of the mobile device, for example similar to the PayPass M/CHIP secure element application distributed by the assignee of the present application, performs the steps of payment source selection, authentication and processing an EMV (Europay, MasterCard and Visa) transaction.

The EMV interoperable payments specification is set forth by EMVCo, LLC (901 Metro Center Boulevard, Mailstop M3-3D, Foster City, Calif., 94404, USA). It will be appreciated that, strictly speaking, the EMV specification defines the behavior of a terminal; however, the portable device can be configured to conform to such EMV-compliant terminal behavior and in this sense is itself EMV-compliant. It will be appreciated that embodiments can be configured in a variety of different ways.

In an example embodiment, a single payment application for all payment sources will be stored in the secure element. The user will be able to select which payment source to use for payment. In some embodiments, the single payment application will be used for physical POS, POS over internet, cardholder authentication, and person-to-person transactions. At the end of the process of FIG. 6, the outcome of the transaction may be displayed to the user (e.g., on both a display device of the mobile device as well as on a merchant website) and the process completes.

Pursuant to some embodiments, the mobile application provides the billing address (and, if shipping is required, the shipping address). Pursuant to some embodiments, the mobile application/secure element can be personalized with additional trusted and secure data, including data associated with the consumer's billing address. This allows the data to be read and verified by the merchant without need to contact the card issuer for validation. For example, the billing address may be checked against a requested shipping address and may be used to fill the default shipping address, thereby saving the customer time (reducing or eliminating the need to perform data entry when interacting with the merchant). In some embodiments, the stored data may be updatable by issuer processing (e.g., the address data may be updated by an issuer if the consumer's billing address changes). Data that may be personalized or loaded into the secure element in this manner may include consumer name, address, email address, or the like.

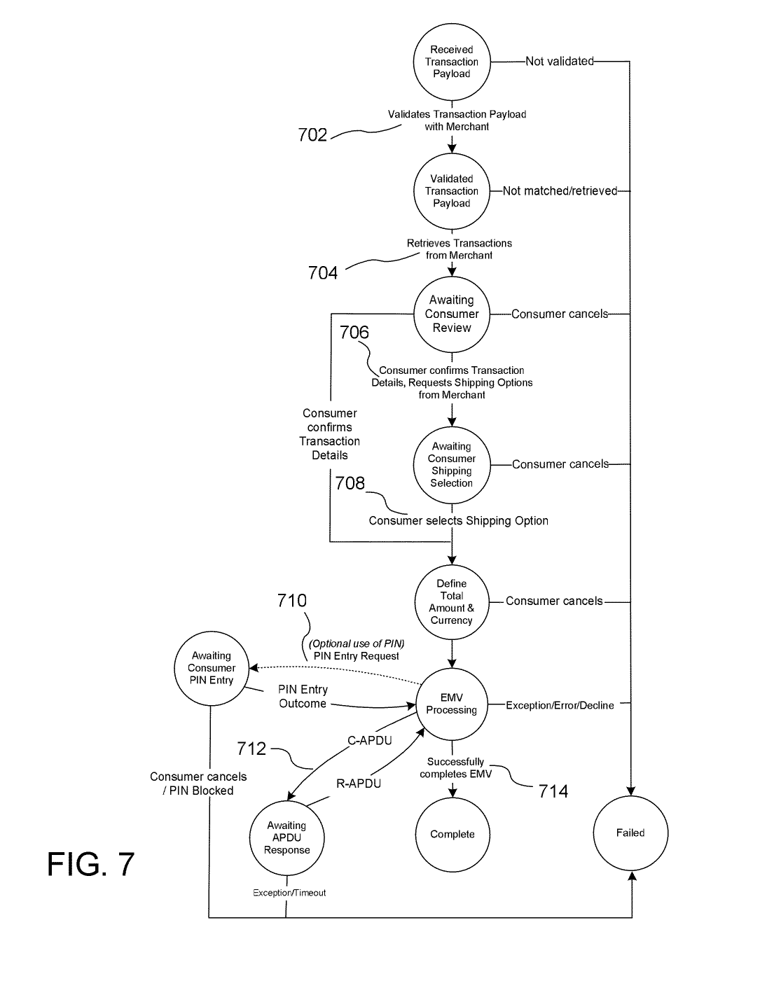

The operation of an example embodiment of the payment gateway will now be described in more detail with reference to FIG. 7. Referring to FIG. 7, in step 702 the payment gateway validates a transaction payload received from a mobile application (where the mobile application received the transaction payload from the merchant as described above). In some embodiments, the transaction payload and data received from the mobile device may include data fields including a transaction payload ID, a mobile timestamp, a payment gateway ID, a merchant display name, a basket ID, a basket timestamp, a version number, a security seal, and a time of creation. The security seal may be the result of a cryptographic computation (such as a Message Authentication Code or “MAC” generation process) over the content of the transaction payload using a HMAC function with a key previously shared between the merchant and the payment gateway

After validation, a secure session is set up with the merchant and the mobile device. All communication in this secure session includes a time bound security token, generated at the payment gateway, and the transaction payload. To enhance security and prevent fraud, the time bound security token will cause the secure session to time out if there are delays. The process steps of 704-708 implement the shopping transaction as described above, and the process steps of 710-714 implement the payment transaction as described above. In this example the payment gateway interacts with the Mobile MasterCard PayPass M/CHIP secure application included with the mobile application.

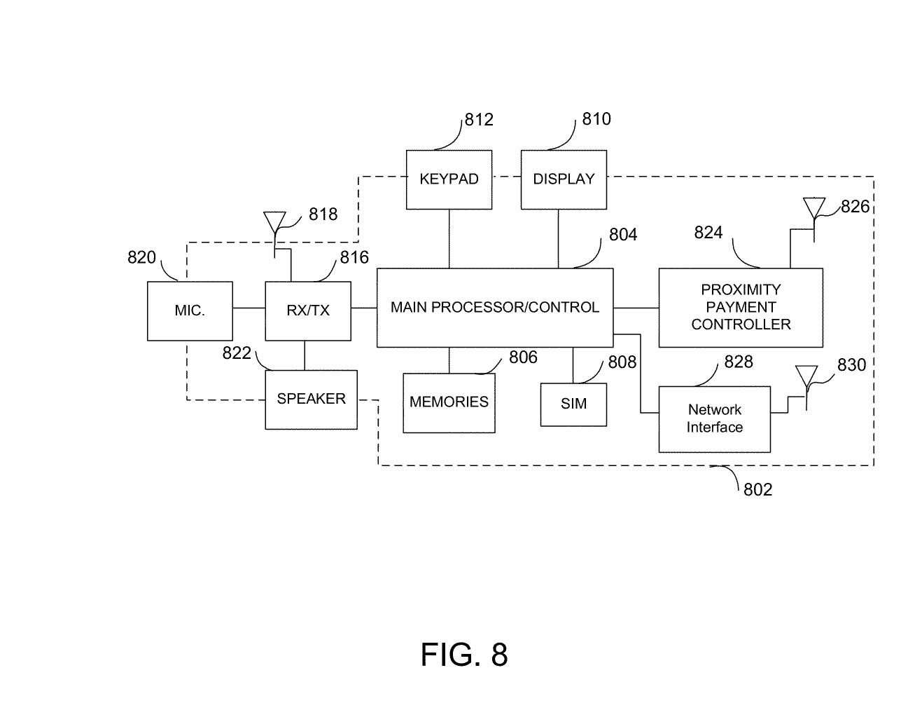

Reference is now made to FIG. 8 which is a block diagram representation of a mobile device 200, in this example a mobile telephone device. The mobile device 200 may include a conventional housing (indicated by dashed line 802 in FIG. 8) that contains and/or supports the other components of the mobile telephone device 200. The mobile device 200 further includes conventional control circuitry 804 for controlling overall operation of the mobile device 200. Other components of the mobile device 200, which are in communication with and/or controlled by the control circuitry 804, include: (a) one or more memory devices 806 (e.g., program and working memory, etc.); (b) a conventional SIM (subscriber identification module) card 808; (c) a keypad 812 (which for present purposes will be understood to include the other buttons, switches and keys referred to or may be implemented as soft keys on the display) for receiving user input; and (d) a display component 810 for displaying output information to the user.

The mobile device 200 also includes conventional receive/transmit circuitry 816 that is also in communication with and/or controlled by the control circuitry 804. The receive/transmit circuitry 816 is coupled to an antenna 818 and provides the communication channel(s) by which the mobile device 200 communicates via the mobile network (not shown), such as, for example, to establish communication with a payment gateway as described herein. The mobile device 200 further includes a conventional microphone 820, coupled to the receive/transmit circuitry 816, for receiving voice input from the user. In addition, a loudspeaker 822 is included to provide sound output to the user, and is coupled to the receive/transmit circuitry 816.

In conventional fashion, the receive/transmit circuitry 816 operates to transmit, via the antenna 818, voice signals generated by the microphone 820, and operates to reproduce, via the loudspeaker 822, voice signals received via the antenna 818. The receive/transmit circuitry 816 may also handle transmission and reception of text messages and/or other data communications via the antenna 818.

The mobile device 200 further includes a contactless interface 824 with an antenna 826, here labeled the proximity payment controller, which can function to read a tag device associated with a POS 104 to receive transaction and other information from the tag device in wireless transactions. The example mobile device 200 also includes network interface hardware 828 having a loop antenna 830 that can function to connect to wireless networks such as Wi-Fi, Bluetooth, etc.

In accordance with conventional teachings, the mobile device 200 may include a “secure element” (not separately shown) which may constitute a portion of the proximity payment controller 824, control circuits 804 or of the SIM card 808. The secure element may store the payment application program and payment card account number and/or other sensitive information related to the payment capabilities of the mobile device 200.

In its hardware aspects, the mobile device 200 may be entirely conventional, but it may be programmed to establish a persistent, secure wireless connection with a payment gateway and to perform shopping functions and payment transactions as described herein.

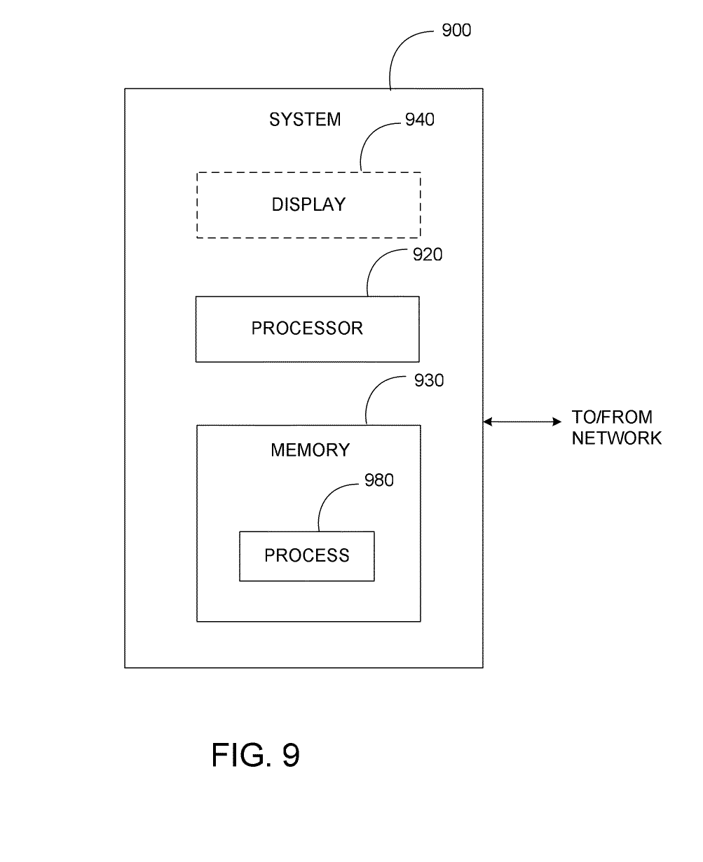

FIG. 9 is a block diagram of a system 900 that can implement part or all of one or more aspects or processes of systems within which cards according to embodiments of the invention can operate or within which methods according to embodiments of the invention can be carried out. As shown in FIG. 9, memory 930 configures the processor 920 to implement one or more aspects of the methods, steps, and functions disclosed herein (collectively, shown as process 980 in FIG. 9). Different method steps can be performed by different processors. The memory 930 could be distributed or local and the processor 920 could be distributed or singular. The memory 930 could be implemented as an electrical, magnetic or optical memory, or any combination of these or other types of storage. It should be noted that if distributed processors are employed, each distributed processor that makes up processor 920 generally contains its own addressable memory space. It should also be noted that some or all of computer system 900 can be incorporated into an application-specific or general-use integrated circuit. For example, one or more method steps could be implemented in hardware in an ASIC rather than using firmware. Display 940 is representative of a variety of possible input/output devices (e.g., displays, mice, keyboards, and so on).

As is known in the art, part or all of one or more aspects of methods and apparatuses may be distributed as an article of manufacture that itself comprises a computer readable medium having computer readable code means embodied thereon. The computer readable program code means is operable, in conjunction with a computer system, to carry out all or some of the steps to perform the methods or create the apparatuses. A computer usable medium may be a tangible computer-readable recordable storage medium (e.g., floppy disks, hard drives, compact disks, EEPROMs, or memory cards; not including a transmission medium or disembodied signal) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). For example, one device could be a physical memory media associated with a terminal and another device could be a physical memory media associated with a processing center.

The computer systems and servers described herein each contain a memory that will configure associated processors to implement methods, steps, and functions. Such methods, steps, and functions can be carried out, for example, by processing capability on various system elements or by any combination of elements. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more aspects of a system can include a computer program comprising computer program code means adapted to perform one or steps when such program is run on a computer, and that such program may be embodied on a tangible computer readable recordable storage medium; for example, in the form of distinct software modules which then execute on one or more hardware processors. Further, a system can include a computer comprising code adapted to cause the computer to carry out one or more steps, together with one or more apparatus elements or features.

Computers discussed herein can be interconnected, for example, by one or more of network, another virtual private network (VPN), the Internet, a local area and/or wide area network (LAN and/or WAN), via an EDI layer, and so on. The computers can be programmed, for example, in compiled, interpreted, object-oriented, assembly, and/or machine languages, for example, one or more of C, C++, Java, Visual Basic, and the like (a non-limiting list of examples), and can also make use of, for example, Extensible Markup Language (XML), known application programs such as relational database applications, spreadsheets, and the like. The computers can be programmed to implement the logic described.

The flow charts and descriptions thereof herein should not be understood to prescribe a fixed order of performing the method steps described therein. Rather, the method steps may be performed in any order that is practicable.

Account selection devices have been depicted as buttons in the Figures. However, persons of skill in the art will realize that other input devices such as switches, pressure sensitive areas, etc. can be utilized.

As used herein and in the appended claims, the term “payment application” refers to a system for handling purchase transactions and related transactions and operated under the name of MasterCard, Visa, American Express, Diners Club, Discover Card or a similar system. In some embodiments, the term “payment card system” or “payment card” may be limited to systems in which member financial institutions issue payment card accounts to individuals, businesses and/or other organizations.

As the term “payment transaction” is used herein and in the appended claims, it should be understood to include the types of transactions commonly referred to as “purchase transactions” in connection with payment card systems. As used herein, the term “verification code” is generally used to refer to cardholder verification codes such as the CVC, CVV or other cardholder verification values or codes used to verify payment card transactions. The term “verification code” may also include EMV cryptograms, a cryptogram in a Universal Cardholder authentication field as part of an e-commerce transaction, or CVC3 in a magstripe transaction.

While QR codes are described herein as mechanisms for transmitting transaction payload data from a merchant (or printed item, or the like) to a mobile device, embodiments may be used with similarly desirable results where the transaction payload data is provided to the mobile device in some other form, such as, for example, as data communicated over a near field communication (“NFC”) interface. For example, the transaction payload may be encoded in an NFC tag or otherwise transmitted to the mobile device as an NFC message.

The above descriptions and illustrations of processes herein should not be considered to imply a fixed order for performing the process steps. Rather, the process steps may be performed in any order that is practicable, including simultaneous performance of at least some steps.

Although the present invention has been described in connection with specific example embodiments, it should be understood that various changes, substitutions, and alterations apparent to those skilled in the art can be made to the disclosed embodiments without departing from the spirit and scope of the invention as set forth in the appended claims.

What is claimed is:

1. A method for operating a mobile device to conduct a transaction, comprising:
obtaining, by a mobile device operating a mobile payment application, a transaction payload from a merchant;
extracting a payment gateway identifier from the transaction payload and establishing a secure communication channel with a payment gateway identified by said payment gateway identifier;
receiving, from said payment gateway, item data associated with said transaction, said item data obtained by said payment gateway from said merchant; and
receiving, from a user operating said mobile device, a confirmation to complete said transaction using a payment account associated with said user and transmitting said confirmation to said payment gateway with payment account credentials associated with said payment account.

2. The method of claim 1, wherein the transaction payload includes at least one of (i) a merchant identifier, (ii) a merchant name, (iii) a payment gateway identifier, (iv) a basket identifier, and (v) a security seal.

3. The method of claim 1, wherein said transaction payload is obtained from said merchant by scanning a code displayed by said merchant, said code encoding data elements of said transaction payload.

4. The method of claim 3, wherein said scanning said code comprises at least one of: (i) operating a camera of said mobile phone to read a bar code, and (ii) operating a wireless reader of said mobile phone to receive data from a near field communication tag.

5. The method of claim 3, wherein said code is displayed by said merchant on a website viewed by said user on a device other than said mobile device.

6. The method of claim 5, wherein said device other than said mobile device is at least one of: (i) a personal computer, (ii) a laptop computer, (iii) a tablet computer, and (iv) a set top box, (v) a second mobile mobile device, (vi) a television, and (vii) a gaming console.

7. The method of claim 3, wherein said code is presented by said merchant on an item of printed media as at least one of: (i) a bar code, (ii) an alphanumeric code, and (iii) an NFC tag.

8. The method of claim 1, wherein said transaction payload is obtained from said merchant by transferring data from a merchant web page to said mobile payment application.

9. The method of claim 1, wherein said transaction payload is obtained from said merchant by transferring data from a merchant mobile application to said mobile payment application.

10. The method of claim 1, wherein said item data obtained by said payment gateway from said merchant are identified using a basket identifier, said basket identifier provided to said payment gateway from said transaction payload.

11. The method of claim 1, wherein said receiving item data associated with said transaction further comprises:
receiving shipping details, said shipping details provided by said merchant to said payment gateway based on said basket identifier; and
determining, by said mobile application, a stored shipping preference of said user.

12. The method of claim 1, wherein said payment account is selected from payment account information stored in a secure element of said mobile device.

13. The method of claim 12, wherein said payment account information stored in a secure element of said mobile device include said payment account credentials, said payment account credentials including at least a primary account number, an expiry date, and a verification code.

14. The method of claim 1, further comprising:
processing said transaction using said payment credentials using a secure payment process.

15. A mobile device, comprising:
a storage device to store a mobile payment application;
a secure element to store payment account information of a user;
a display;
a communication device;
a computer-readable non-transitory storage medium comprising instructions to:
obtain, by said mobile payment application, a transaction payload from a merchant;
extract a payment gateway identifier from the transaction payload and operating said communication device to establish a secure communication channel with a payment gateway identified by said payment gateway identifier;
receive, from said payment gateway, item data associated with said transaction, said item data obtained by said payment gateway from said merchant; and
receive, from a user operating said mobile device, a confirmation to complete said transaction using a payment account associated with said user and transmitting said confirmation to said payment gateway with payment account credentials associated with said payment account.

16. The mobile device of claim 15, wherein said transaction payload is obtained from said merchant by scanning a code displayed by said merchant, said code encoding data elements of said transaction payload including at least a merchant identifier, a merchant name, a payment gateway identifier, a basket identifier, and a security seal.

17. The mobile device of claim 16, wherein said code is displayed by said merchant on at least one of (i) a website viewed by said user on a device other than said mobile device, (ii) on an item of printed media, and (iii) on a display of said mobile device.

18. The mobile device of claim 15, wherein said item data obtained by said payment gateway from said merchant are identified using a basket identifier, said basket identifier provided to said payment gateway from said transaction payload.

19. The mobile device of claim 15, further comprising:
displaying shipping details associated with said transaction on said display device;
determining whether a stored shipping preference of said user is available for said transaction; and
receiving a selection from said user of a shipping preference for said transaction.

20. The mobile device of claim 15, wherein said payment account information stored in said secure element of said mobile device include said payment account credentials, said payment account credentials including at least a primary account number, an expiry date, and a verification code.

21. A payment system for conducting a transaction involving a user operating a mobile device and a merchant, comprising:
a merchant offering items for sale by a merchant, said merchant identified by a merchant identifier;
a payment gateway, said payment gateway providing processing services for said merchant website and identified by a payment gateway identifier;
a mobile device operated by a user, said mobile device storing a payment application stored thereon and information associated with at least a first payment account of said user, the mobile device having a processor operative with computer-readable non-transitory storage medium comprising instructions to:
obtain, by said payment application, a transaction payload from said merchant;
extract said payment gateway identifier from the transaction payload and operating said communication device to establish a secure communication channel with said payment gateway identified by said payment gateway identifier;
receive, from said payment gateway, item data associated with said transaction, said item data obtained by said payment gateway from said merchant; and
receive, from a user operating said mobile device, a confirmation to complete said transaction using a payment account associated with said user and transmitting said confirmation to said payment gateway with payment account credentials associated with said payment account.

22. A method for conducting a remote transaction, comprising:
initiating a transaction between a mobile device and a remote merchant by delivering a transaction payload to the mobile device;
processing the transaction payload and initiating a connection to a payment gateway;
validating, at the payment gateway, the transaction payload;
presenting the transaction payload and a set of identifiers to the remote merchant for validation; and
establishing a first and a second communication channel between the mobile device and the payment gateway to complete said remote transaction.

23. The method of claim 22, wherein said initiating a transaction comprises:
operating said mobile device to scan a code associated with a merchant.

24. The method of claim 22, wherein said initiating a transaction comprises:
operating a browser on said mobile device to interact with a merchant web server.

25. The method of claim 22, wherein said initiating a transaction comprises:
operating a payment application on said mobile device to interact with a merchant web server.
